(19) United States
(12) Patent Application Publication
(10) Pub. No.: US 2021/0284493 A1
(43) Pub. Date: Sep. 16, 2021

(54) MONITORING OF OPERATING STATUS OF MACHINE PASSENGER

(71) Applicant: Otis Elevator Company, Farmington, CT (US)

(72) Inventors: Yu Zhang, Shanghai (CN); Shenhong Wang, Shanghai (CN)

(21) Appl. No.: 17/099,438

(22) Filed: Nov. 16, 2020

(30) Foreign Application Priority Data
Mar. 16, 2020 (CN) 202010181030.2

(51) Int. Cl. B66B 5/00; G08B 23/00; B66B 1/34; B66B 5/02

(52) U.S. Cl. CPC B66B 5/0012; G08B 23/00; B66B 5/0018; B66B 5/021; B66B 1/3461

(57) ABSTRACT

A method of monitoring a running state of a machine passenger capable of wirelessly interacting with an elevator system, which includes a judgement step and a first state determination step; in the judgement step, judging whether a response command for state polling information fed back from the machine passenger is received, and judging whether first state representation information actively sent from the machine passenger for representing that its running state is abnormal is received; and in the first state determination step, determining that a respective machine passenger is in an abnormal running state based on a first judgement result of not receiving the response command and a second judgement result of receiving the first state representation information.

### CROSS-REFERENCE TO RELATED APPLICATION

This application claims priority from Chinese patent application No. 202010181030.2, filed on Mar. 16, 2020, the entirety of which is hereby incorporated by reference herein and forms a part of the specification.

### FIELD OF THE INVENTION

The invention belongs to the technical field of Elevators and relates to monitoring a running state of a machine passenger capable of wirelessly interacting with an elevator system, and specifically relates to a method, a computer readable storage medium, a computer device for monitoring the running state of the machine passenger capable of wirelessly interacting with the elevator system and an elevator system using the computer device.

### BACKGROUND OF THE INVENTION

With the development of intelligent robot technology, more and more intelligent robots come into buildings to provide services for people, e.g., providing item shipping services in hotels, office buildings. Thus, there is a situation where the robot is a passenger of an elevator system in a building, i.e., with respect to an elevator system, a robot may take an elevator as a machine passenger, and may even wirelessly interact with the elevator system to send various commands, e.g. issuing commands for requesting registration of a destination floor within an elevator car, issuing commands for requesting a call at a landing hall, and so on.

However, it is likely that the machine passenger itself is not always in an ideal normal running state, for example, it is likely that a machine passenger is in an abnormal running state that is unexpected to appear due to internal faults or external factors.

### SUMMARY OF THE INVENTION

According to a first aspect of the present invention, there is provided method of monitoring a running state of a machine passenger capable of wirelessly interacting with an elevator system, which comprises: judgement step: judging whether a response command for state polling information fed back from the machine passenger is received, and judging whether first state representation information actively sent from the machine passenger for representing that its running state is abnormal is received; and first state determination step: determining that the respective machine passenger is in an abnormal running state based on a first judgement result of not receiving the response command and a second judgement result of receiving the first state representation information.

The method according to an embodiment of the invention, further comprising: state polling step: wirelessly sending the state polling information to the machine passenger.

The method according to yet another embodiment or any of the above embodiments of the present invention, wherein the state polling information is sent to the machine passenger periodically and in case that the machine passenger is in a normal running state, the response command from the machine passenger can be received periodically.

The method according to yet another embodiment or any of the above embodiments of the present invention, wherein in the first state determination step, if the first state representation information is received, the respective machine passenger is determined to be in an abnormal running state.

The method according to yet another embodiment or any of the above embodiments of the present invention, wherein in the first state determination step, if the response command is not received and the first state representation information is not received, the respective machine passenger is determined to be in a running state of a network connection exception or is in an abnormal running state of a crash.

The method according to yet another embodiment or any of the above embodiments of the present invention, wherein if the response command is received but the first state representation information is not received, the respective machine passenger is determined to be in a normal running state.

The method according to yet another embodiment or any of the above embodiments of the present invention, wherein the first state representation information further comprises one or more of the following: an identifier of the respective machine passenger, a fault type of the respective machine passenger, position information of the respective machine passenger relative to the elevator system.

The method according to yet another embodiment or any of the above embodiments of the present invention, wherein the response command further comprises one or more information of the following: an identifier of the respective machine passenger, position information of the respective machine passenger relative to the elevator system.

The method according to yet another embodiment or any of the above embodiments of the present invention, further comprising: prompting step: sending at least first prompt information representing that the respective machine passenger is in an abnormal running state to a maintenance management system.

The method according to yet another embodiment or any of the above embodiments of the present invention, wherein the first prompt information further comprises one or more of the following: an identifier of the respective machine passenger, a fault type of the respective machine passenger, position information of the respective machine passenger relative to the elevator system.

The method according to yet another embodiment or any of the above embodiments of the present invention, further comprising: elevator run result acquisition step: acquiring a respective elevator run result corresponding to one or more commands from a certain machine passenger that have been sent to an elevator control device of the elevator system, and judging whether the elevator run result includes a run exception; association step: if the elevator run result includes a run exception, judging whether the same run exception occurring multiple times is associated with commands sent by the same machine passenger; and second state determination step: if judged as “YES”, the machine passenger is determined to be in an abnormal running state.

The method according to yet another embodiment or any of the above embodiments of the present invention, wherein in the elevator run result acquisition step, if the elevator run result includes the run exception, second prompt information is issued.

The method according to yet another embodiment or any of the above embodiments of the present invention, wherein the run exception comprises one or more of: the persistent opening time of a car door/landing door being longer than or equal to a respective predetermined value; the opening/closing frequency of the car door/landing door being greater than or equal to a respective predetermined value; the persistent traveling time of the car being shorter than or equal to a respective predetermined value; the persistent traveling time of the car being longer than or equal to a respective predetermined value; the elevator control device having a logical error.

The method according to yet another embodiment or any of the above embodiments of the present invention, wherein in the state polling step, from a beginning of the call of the machine passenger to an end of an elevator-taking process corresponding to the call, continuously sending the state polling information wirelessly to the machine passenger periodically.

The method according to yet another embodiment or any of the above embodiments of the present invention, wherein the judgement step further comprises: judging whether a second state representation information actively sent from the machine passenger for representing that its running state is normal is received; and, the method further comprises the steps of: second state determination step: determining that the respective machine passenger is in a normal running state based on a third judgement result of receiving the second state representation information.

According to a second aspect of the present invention there is provided a computer device comprising a memory, a processor, and a computer program stored on the memory and executable on the processor, wherein the processor, when executing the program, implements the steps of any method described above.

According to a third aspect of the present invention there is provided a computer readable storage medium having stored thereon a computer program, wherein the program is executable by a processor to implement the steps of any method described above.

According to a fourth aspect of the present invention, there is provided an elevator system comprising one or more elevator cars, an elevator control device for controlling the traveling of the one or more elevator cars; wherein the system further comprises: running state monitoring unit configured in the computer device described above; wherein the elevator control device monitors the running state of a machine passenger capable of wirelessly interacting with the elevator system through the running state monitoring unit.

The elevator system according to an embodiment of the invention, wherein the computer device is separately external relative to the elevator control device and is communicatively connected with the elevator control device.

The above features and operations of the present invention will become more apparent from the following description and the accompanying drawings.

### BRIEF DESCRIPTION OF THE DRAWINGS

The above and other objects and advantages of the present invention will become more complete and apparent from the following detailed description taken in conjunction with the drawings, wherein like or similar elements are designated by like numerals.

FIG. 1 is a schematic diagram of an elevator system according to an embodiment of the present invention, wherein an elevator system wirelessly interacting with one or more machine passengers using a running state monitoring apparatus of an embodiment of the present invention is illustrated.

FIG. 2 is a schematic diagram of a basic structure of a running state monitoring apparatus or computer device according to an embodiment of the present invention.

FIG. 3 is a schematic diagram of a module structure of a running state monitoring apparatus according to an embodiment of the present invention.

FIG. 4 is a flowchart of a method of monitoring a running state of a machine passenger according to a first embodiment of the present invention.

FIG. 5 is a flowchart of a method of monitoring a running state of a machine passenger according to a second embodiment of the present invention.

FIG. 6 is a flowchart of a method of monitoring a running state of a machine passenger according to a third embodiment of the present invention.

FIG. 7 is a flowchart of a method of monitoring a running state of a machine passenger according to a fourth embodiment of the present invention.

### DETAILED DESCRIPTION OF THE EMBODIMENT(S) OF THE INVENTION

The present invention will now be described more fully with reference to the accompanying drawings, in which exemplary embodiments of the invention are shown. This invention may, however, be implemented in many different forms and should not be construed as limited to the embodiments set forth herein. Rather, these embodiments are provided so that this disclosure become thorough and complete, and will fully convey the concept of the invention to those skilled in the art.

Although features of the present invention are disclosed in connection with several embodiments/only one of embodiments, as may be desired and/or advantageous for any given or identifiable function, this feature may be combined with other embodiments/one or more other features of embodiments.

Some block diagrams shown in the figures are functional entities and do not necessarily have to correspond to physically or logically separate entities. These functional entities may be implemented in software or in one or more hardware modules or integrated circuits, or in different processing apparatus and/or microcontroller apparatus.

The machine passenger in the following embodiments of the present invention may be various types of movable machine bodies that may be associated with an elevator system, the machine passenger may specifically be a robot that may take an elevator, for example, a robot for take-out, a robot for meal delivering, a robot for expressage, etc., the machine passenger may also be a transportation vehicle that autonomously moves under control. It will be understood that the specific type, structure, and/or use of a machine passenger may be varied widely, which is not limited by the following embodiments of the present invention.

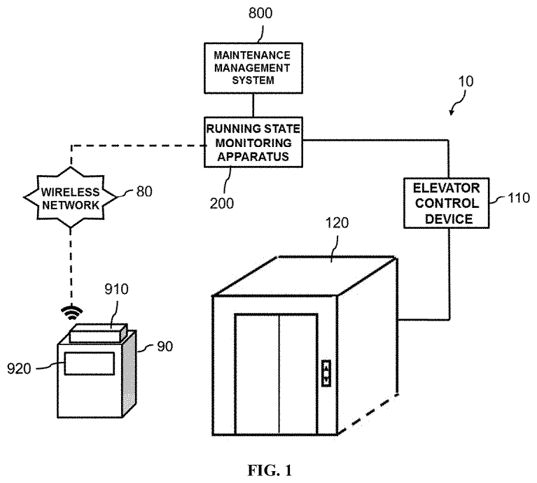

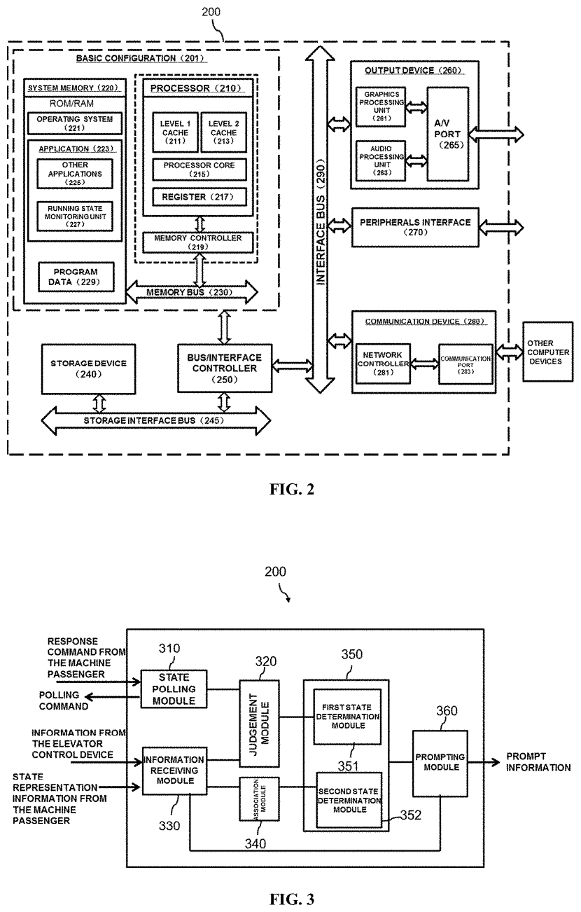

Shown in FIG. 1 is a schematic diagram of an elevator system according to an embodiment of the present invention, which illustrates an elevator system wirelessly interacting with one or more machine passengers using a running state monitoring apparatus of an embodiment of the present invention; shown in FIG. 2 is a schematic diagram of a basic structure of a running state monitoring apparatus or computer device according to an embodiment of the present invention; shown in FIG. 3 is a schematic diagram of a module structure of a running state monitoring apparatus according to an embodiment of the present invention.

As shown in FIG. 1, the elevator system 10 of the present invention includes one or more elevator cars 120, and an elevator control device 110, which may be implemented by, for example, an elevator control cabinet, a group controller, or the like, which may be used to control one or more elevator cars 120 to travel in the hoistway. The specific implementation of the elevator control device 110 is not limiting.

It will be understood that the elevator system 10 may also include other conventional components not shown in the figures, e.g. traction apparatus, counterweights, and the like.

Continuing as shown in FIG. 1, the elevator system 10 wirelessly interacts with one or more machine passengers 90 using the running state monitoring apparatus 200 of an embodiment of the present invention.

In an embodiment, the running state monitoring apparatus 200 may constantly send or broadcast state polling information to one or more machine passengers 90, a response module 910 may be disposed in the machine passenger 90, which is capable of continuously feeding back a response command for state polling information when the machine passenger 90 is not in an abnormal running state for example a crash or network connection exception; thus, the running state monitoring apparatus 200 may further judge whether the machine passenger 90 is in an abnormal running state by judging whether a response command for state polling information from the machine passenger 90 may be normally received, thereby the running state monitoring apparatus 200 may be aware of the abnormal running of the machine passenger 90 timely.

In yet another embodiment, a state representation module 920 may be disposed in the machine passenger 90, the state representation module 920 of which may acquire state representation information representative of the running state of the machine passenger 90 by means of a fault diagnosis function of a fault diagnosis module or itself, for example, when the machine passenger 90 is diagnosed with a fault, the state representation module 920 generates a first state representation information representing that the running state of the machine passenger 90 is abnormal, and actively sends the first state representation information to the running state monitoring apparatus 200 via the wireless network 80, the running state monitoring apparatus 200 may thereby be aware of the abnormal running of the machine passenger 90 timely. In other embodiments, the state representation information may also include a second state representation information for the normal running state of the machine passenger 90, the state representation module 920 generates a corresponding second state representation information when, for example, the machine passenger 90 is not diagnosed with a fault, and actively sends the second state representation information to the running state monitoring apparatus 200 via the wireless network 80. The state representation information may be continuously uploaded to the running state monitoring apparatus 200 periodically.

In yet another embodiment, the running state monitoring apparatus 200 may also have an interactive security control function, which may be implemented as an interactive control apparatus between the machine passenger 90 and the elevator control device 110. When the machine passenger 90 needs to take a certain elevator car 120 of the elevator system 10 to a destination floor, the machine passenger 90 may send a corresponding command and the command may be transmitted via the wireless network 80 to the running state monitoring apparatus 200, the command is uploaded to the elevator control device 110 in case that the running state monitoring apparatus 200 determines that the command is secure with respect to the elevator system 10, avoiding causing the elevator system to run abnormally (e.g., running unstably, running disorderly, etc.) due to the elevator control device 110 being affected by the insecure command, and also reducing the workload resulted from the elevator control device 110 handling excessive insecure commands from the machine passenger 90. Thus, in the elevator system 10 of embodiments of the present invention, the elevator control device 110 does not interact directly with the machine passenger 90, nor does the command issued by the machine passenger 90 is directly sent to the elevator control device 110, but instead is detected and verified in the running state monitoring apparatus 200 to determine its security with respect to the elevator system 10.

Specifically, a wireless communication module, e.g. those supporting 4G/5G/Wifi communication, may be disposed on the machine passenger 90, a respective wireless communication module may also be disposed in the running state monitoring apparatus 200, so that it may perform wireless communication connection with one or more machine passengers 90 via the wireless network 80 in real time. The wireless communication module of the running state monitoring apparatus 200 (e.g. the communication device 280 as shown in FIG. 2) may be configured with a respective interface to receive the command (e.g., a response command) from individual machine passenger 90, which may, of course, receive information (e.g., dispatch information, elevator running state information, and the like) from the elevator system 10.

In an embodiment, the running state monitoring apparatus 200 may be part of the elevator system 10, which is separately external relative to the elevator control device 110 and is communicatively connected with the elevator control device 110; for example, the running state monitoring apparatus 200 may be manufactured separately and mounted in the elevator system 10 by connecting to the elevator control device 110 by way of a wired connection, so that an existing elevator system with the function of the running state monitoring apparatus 200 of the present invention may be easily and simply reformed, e.g., implemented by an external addition of one running state monitoring apparatus 200.

It will be understood that the running state monitoring apparatus 200 may also be implemented integrated into the elevator control device 110 as needed; a running state monitoring apparatus 200 may also be shared with a plurality of elevator systems 10.

In an embodiment, the running state monitoring apparatus 200 may also be communicatively connected with or be part of the maintenance management system 800, which may manage, for example, various maintenance work of the machine passenger 90 and may also manage various maintenance work of the elevator system 10. The running state monitoring apparatus 200 may upload the first prompt information and/or the second prompt information illustrated in the following example to the maintenance management system 800, which is very advantageous for the maintenance management personnel to quickly and conveniently locate abnormal conditions and timely maintain machine passengers 90 and the like.

As shown in FIG. 2, the running state monitoring apparatus 200 may be implemented by a computer device 200 of an embodiment of the present invention, the computer device 200 may be a general purpose computer, a special purpose computer, or a machine having computing and processing function based on a predetermined program, which may even be implemented by cloud computing.

Referring to the specific exemplary frame structure of the computer device 200 of the embodiment shown in FIG. 2, in a basic configuration 201, the computer device 200 typically includes a system memory 220 and one or more processors 210. The memory bus 230 may be used for communication between the processor 210 and the system memory 220.

Depending on the desired configuration, the processor 210 may be any type of processors, including but not limited to: a microprocessor (μP), a microcontroller (μC), a digital signal processor (DSP), or any combination thereof. The processor 210 may include one or more levels of cache such as a level 1 cache 211 and a level 2 cache 213, and may also include a processor core 215 and a register 217. The example processor core 215 may include an arithmetic logic unit (ALU), a floating point unit (FPU), a digital signal processing core (DSP Core), or any combination thereof. The example memory controller 219 may be used with the processor 210, or in some embodiments, the memory controller 219 may be a built-in part of the processor 210.

Depending on the desired configuration, the system memory 220 may be any type of memory, including but not limited to: volatile memory (such as RAM), non-volatile memory (such as ROM, flash memory, etc.), or any combination thereof. The system memory 220 may include an operating system 221, one or more applications 223, and program data 229. In some implementations, application 223 may be arranged to operate on an operating system with program data 229.

The computer device 200 may also include an interface bus 290 that facilitates communication from various interface devices (e.g., output device 260, peripherals interface 270, and communication device 280) to basic configuration 102 via bus/interface controller 250. Example output device 260 includes a graphics processing unit 261 and an audio processing unit 263. They may be configured to facilitate communication with various external devices such as a display or speaker via one or more A/V ports 265. Example peripherals interface 270 may include a serial interface controller and a parallel interface controller, which may be configured to facilitate communication via one or more I/O ports and external devices such as input devices (e.g., keyboards, mice, pens, voice input devices, touch input devices), or other peripherals (e.g., printers, scanners, and the like). The example communication device 280 may include a network controller 281, which may be arranged to be suitable for communicating with one or more other computer devices (e.g., computer devices on a machine passenger 90) via one or more communication ports 283.

Continuing as shown in FIG. 2, in an embodiment, a running state monitoring unit 227 is also included in the application 223 of the computer device 200. The running state monitoring unit 227 may be installed as a stand-alone software in the computer device 200 or embodied only as a piece of code; it will be understood that the existence form of the running state monitoring unit 227 in the computer device 200 is not limiting. The running state monitoring unit 227 may be used to implement a running state monitoring function of the machine passenger 90, also i.e.: judging whether a response command for state polling information fed back from the machine passenger 90 is received, and/or judging whether a first state representation information actively sent from the machine passenger 90 for representing that its running state is abnormal is received; and determining that the respective machine passenger 90 is in an abnormal running state based on a first judgement result of not receiving the response command and/or a second judgement result of receiving the first state representation information. Thus, the running state monitoring unit 227 facilitates realizing timely determination of an abnormal running state in the machine passenger 90.

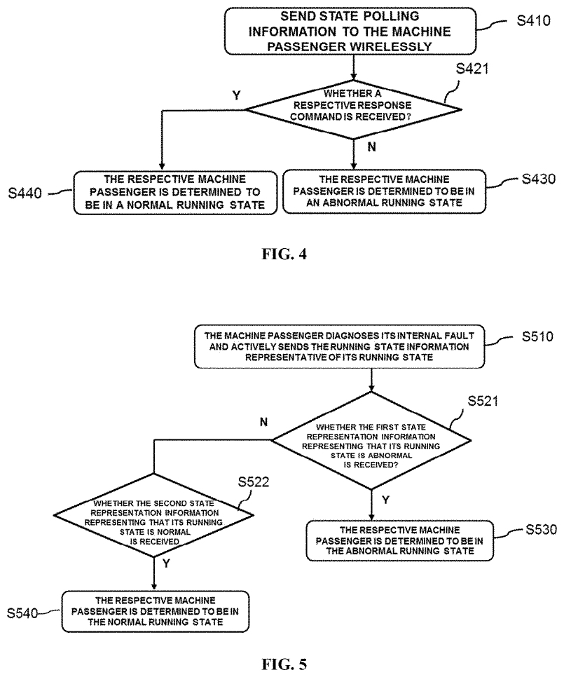

The running state monitoring unit 227 may be contained in the elevator system 10 or the maintenance management system 800 and serves as a functional component of the elevator system 10 or the maintenance management system 800. The specific functions and implementations of the running state monitoring unit 227 may be illustrated in conjunction with a method of monitoring the running state of a machine passenger (hereinafter referred to simply as “a running state monitoring method”) of the embodiment shown in FIGS. 4-7 below.

Referring to FIG. 3, a schematic diagram of a module structure of a running state monitoring apparatus 200 or a computer device 200 of an embodiment of the present invention is shown. The running state monitoring apparatus 200 is configured with a state polling module 310, a judgement module 320, and a state determination module 350; the running state monitoring apparatus 200 is further configured with an information receiving module 330, an association module 340, and even configured with a prompting module 360.

Wherein the state polling module 310 is to wirelessly send or broadcast state polling information to the machine passenger 90, as well as receive response commands (if any) for state polling information fed back from the machine passenger 90. The information receiving module 330 may be used to receive state representation information actively sent from the machine passenger 90, e.g. a first state representation information (if any) for representing that its running state is abnormal, and the information receiving module 330 may further be used to acquire elevator run results, specifically to acquire respective elevator run results corresponding to one or more commands from a certain machine passenger 90 that have been sent to the elevator control device 110 (e.g., commands for requesting registration of a destination floor, commands for requesting keeping the car door open), and to judge whether the elevator run result contains a run exception.

Wherein the judgement module 320 may be coupled with the state polling module 310 and the information receiving module 330, the judgement module 320 is used for judging whether a response command for state polling information fed back from the machine passenger 90 is received, and/or judging whether a first state representation information actively sent from the machine passenger 90 for representing that its running state is abnormal is received; the judgement module 320 may send its judgement result (e.g., a first judgement result of not receiving the response command, a second judgement result of receiving the first state representation information) to the state determination module 350. It will be understood that, the information receiving module 340 may, of course, be further configured to receive various information (e.g., current running state information of the elevator system 10, etc.) from the elevator control device 110 as needed.

Wherein the state determination module 350 is used for determining a current running state of the machine passenger 90, which may include a first running state determination module 351 that may determine that the respective machine passenger 90 is in an abnormal running state based on a first judgement result of not receiving the response command and/or a second judgement result of receiving the first state representation information. Of course, the first running state determination module 351 may also determine that the respective machine passenger 90 is in a normal running state based on the third judgement result of receiving the second state representation information. Wherein the association module 340 may be used to implement the following: if the elevator run result includes a run exception, then judging whether the same run exception occurring multiple times is all associated with an command sent by the same machine passenger 90, e.g. judging whether the same run exception that occurs repeatedly (at least twice) within a predetermined time period is all associated with a certain command or a certain type of command sent by the same machine passenger 90, if judged as “YES”, then this run exception is likely to be caused by a certain type of abnormal run (e.g., failure) of the machine passenger 90.

Wherein the state determination module 350 may further include a second running state determination module 352 that may receive a judgement result of the association module 340, and if judged as “YES”, then the second running state determination module 352 may determine that the machine passenger 90 is in an abnormal running state.

Wherein the prompting module 360 may be coupled with an external maintenance management system 800, which may issue respective prompt information to the maintenance management system 800 based on the result information of the state determination module 350, and may also issue respective prompt information (e.g., alarm information) to the maintenance management system 800 based on the judgement result (e.g., whether the elevator run result includes a run exception) of the information receiving module 330.

As such, if the machine passenger 901 interacting with the elevator system 10 is in an abnormal running state (e.g., a crash, a network connection exception, an internal functional fault, etc.), the running state monitoring apparatus 200 may discover timely, which is helpful for management personnel to perform maintenance operation and the like on the machine passenger 901, and may also avoid causing negative effect on the running of the elevator system 10 (e.g., resulting in abnormal running of the elevator system 10, affecting the passenger experience, etc.) by the machine passenger 90 in the abnormal state.

The method of monitoring the running state of the machine passenger and the respective specific configuration of individual modules in the above-described running state monitoring apparatus 200 of multiple embodiments of the present invention are illustrated below further in conjunction with the flowcharts of the running state monitoring methods shown in FIGS. 4-7.

Shown in FIG. 4 is a flowchart of a running state monitoring method according to a first embodiment of the present invention. As shown in FIG. 4, the running state monitoring method of the first embodiment judges whether the respective machine passenger is in an abnormal running state by means of state polling information issued from one side of the running state monitoring apparatus 200 and a response command of the machine passenger 90 for the state polling information.

First, in step S410, wirelessly sending the state polling information (i.e., a state polling step) to the machine passenger 90. Wherein the manner in which the state polling information is sent may be determined according to the respective wireless communication protocol and/or interface protocol, for example, the state polling information may be sent in a broadcast manner. In an embodiment, the state polling information is continuously sent or broadcast from the running state monitoring apparatus 200 to the machine passenger 90 periodically, enabling continuous monitoring of the machine passenger 90.

As a machine passenger 90, if it is in a normal running state, it will normally feedback the respective response commands periodically to represent that currently it is likely to be in a normal running state; if the machine passenger 90 is in certain abnormal running states (e.g., a crash, a wireless network connection exception, etc.), it fails to feedback the respective response command. As such, the state polling information may be periodically sent from the running state monitoring apparatus 200 to the machine passenger 90, and in case that the machine passenger 90 is in a normal running state, the running state monitoring apparatus 200 may also periodically receive response commands from the machine passenger 90.

Further, in step S421, it is judged whether a response command for the state polling information fed back from the machine passenger 90 is received; if it is judged as “NO” (i.e., the response command is not received), the process proceed to step S430 where it is determined that the respective machine passenger 90 is in an abnormal running state. Optionally, if it is judged as “YES”, the process may also proceed to step S440 where it is determined that the respective machine passenger 90 is in a normal running state.

As such, it is possible to quickly and conveniently discover whether the machine passenger 90 is in an abnormal running state, and in particular to effectively discover the abnormal running state where the machine passenger 90 fails to interact with the running state monitoring apparatus 200 or the elevator system 10, for example, when a machine passenger 90 fails to come out of the elevator car 120 due to a fault such as a crash, such abnormal running state may be discovered timely by the running state monitoring apparatus 200 or the running state monitoring method of the embodiment.

It should be noted that, in step S430, when the respective machine passenger 90 is determined to be in a normal running state based on the first judgement result of not receiving the response command, the first judgement result is not necessarily the only element for deriving the determination result, e.g., in order to obtain a more accurate determination result, the determination result may also be derived based on other elements (e.g., the second judgement result, etc.).

Shown in FIG. 5 is a flowchart of a running state monitoring method according to a second embodiment of the present invention. As shown in FIG. 5, the running state monitoring method of the second embodiment judges whether the respective machine passenger 90 is in an abnormal running state by means of the state representation information actively issued from one side of the machine passenger 90.

Specifically, in step S510, the machine passenger 90 diagnoses its internal fault and actively sends the running state information representative of its running state. Wherein, the machine passenger 90 may continuously issue state representation information (e.g., first state representation information or second state representation information) to the running state monitoring apparatus 200 periodically, the state representation information may reflect the running state of the machine passenger 90, and may even include specific fault information. In particular, in the event that certain functional modules inside the machine passenger 90 fail (e.g., a walking mechanism jam, etc.), the machine passenger 90 may actively send first state representation information for representing that its state is abnormal to the running state monitoring apparatus 200.

It should be noted that, a respective fault diagnosis module may be configured inside the machine passenger 90 to acquire respective fault information, thereby determining its state exception; the specific diagnosis manner of internal faults is not limiting.

Further, in step S521, it is judged whether the running state monitoring apparatus 200 receives the first state representation information actively sent from the machine passenger 90 for representing that its state is abnormal. If judged as “YES”, the machine passenger 90 is determined to be in an abnormal running state, i.e. step S530.

Optionally, if judged as “NO” in step S521, the process may also further proceed to step S522, where it is judged whether the running state monitoring apparatus 200 receives the second state representation information actively sent from the machine passenger 90 for representing that its state is normal; if judged as “YES”, the process proceeds to step S540, where it is determined that the respective machine passenger 90 is in a normal running state.

As such, it is possible to quickly and conveniently discover whether the machine passenger 90 is in an abnormal running state, and in particular to effectively discover the abnormal running state where the machine passenger 90 may normally interact with the running state monitoring apparatus 200 or the elevator system 10 while its certain functional modules inside fail, when a machine passenger 90 fails to come out of the elevator car 120 due to a fault (e.g., a walking mechanism jam, the power source is insufficient for driving it to walk, certain control modules are hijacked by hackers, etc.), the running state monitoring method of the above embodiments may discover such abnormal running state timely, thereby timely maintaining the machine passenger so as to avoid machine passenger running abnormally having negative effect on the normal running of the elevator system (e.g. resulting in abnormal running of the elevator system, and degrading the experience of the passenger taking an elevator).

It should be noted that, in step S530, when the respective machine passenger 90 is determined to be in the normal running state based on the second judgement result of receiving the first state representation information, the second judgement result is not necessarily the only element for deriving the determination result, for example, in order to obtain a more accurate determination result, the determination result may also be derived based on other elements (e.g., the first judgement result, etc.).

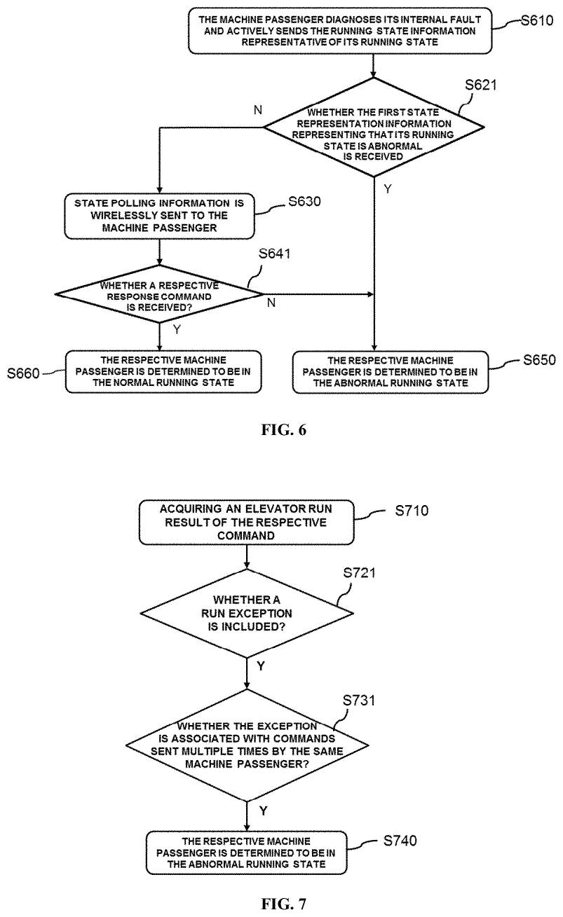

It should be understood that the abnormal running state of the machine passenger 90 is varied widely and may correspond to different types of machine passengers 90, which may also differ in their corresponding abnormal running state, and even more new abnormal running state might emerge in the future. The running state monitoring methods of the first and second embodiments of the above examples are behaviors with differentiation in determining a variety of specific abnormal running state, e.g. there may be shortcomings (e.g., insufficient accuracy) in determining a certain specific abnormal running state, but there is an advantage in determining another abnormal running state; thus, starting from their respective advantages, the methods may be applied in combination with each other, for example, the above third manner is used in combination with the third manner, that is, the running state of the machine passenger 90 is judged based on both the response command and the state representation information, i.e. the running state monitoring method of the third embodiment of the example of FIG. 6 below.

Shown in FIG. 6 is a flowchart of a running state monitoring method according to a third embodiment of the present invention. As shown in FIG. 6, the running state monitoring method of the third embodiment judges the running state of the machine passenger 90 by means of both the response command and the state representation information.

Specifically, in step S610, which is similar to step S510, the machine passenger 90 diagnoses its internal fault and actively sends running state information representative of its running state.

Further, in step S621, it is judged whether the running state monitoring apparatus 200 receives the first state representation information actively sent from the machine passenger 90 for representing that its state is abnormal. If judged as “YES”, the machine passenger 90 is determined to be in an abnormal running state, i.e. step S650. If judged as “NO”, the process may proceed to step S630 for further state monitoring.

In step S630, which is similar to step S410, state polling information is wirelessly sent to the machine passenger 90.

Step S641, it is judged whether a response command for the state polling information fed back from the machine passenger 90 is received; if judged as “NO” (i.e., the response command is not received), the process proceed to step S650 where the respective machine passenger 90 is determined to be in an abnormal running state. Optionally, if judged as “YES”, the process proceed to step S660 where the respective machine passenger 90 is determined to be in a normal running state.

As such, it is possible to more fully and accurately discover whether the machine passenger 90 is in an abnormal running state.

Shown in FIG. 7 is a flowchart of a running state monitoring method according to a fourth embodiment of the present invention. As shown in FIG. 7, in step S710, acquiring a respective elevator run result corresponding to one or more commands from a certain machine passenger 90 which have been sent to the elevator control device 110.

In step S721, it is judged whether the elevator run result includes a run exception (e.g., unstable elevator running, abnormal running, disorder of the elevator system, etc.).

Specifically, the run exception includes one or more of the following: a persistent opening time of a car door/landing door being greater than or equal to a respective predetermined value, the opening/closing frequency of the car door/landing door being greater than or equal to a respective predetermined value, the persistent traveling time of the car being shorter than or equal to a respective predetermined value, the persistent traveling time of the car being longer than or equal to a respective predetermined value, the elevator control device having a logical error, and so on.

If the elevator run result includes a run exception (i.e., in step S721 it is judged as “YES”), the process proceeds to step S731 where it is judged whether the same run exception occurring multiple times (e.g. N times, N being greater than or equal to 2) is associated with commands sent multiple times (e.g., N times) by the same machine passenger; if judged as “YES”, it is determined that the machine passenger is in an abnormal running state, i.e. step S740.

Optionally, if the elevator run result includes a run exception, a second prompt information (e.g., alarm information regarding the run exception of the elevator system) is issued, which may be sent to, for example, the maintenance management system 800 to enable relevant staff to timely respond.

It should be noted that, if the same run exception is associated with commands sent by multiple different machine passengers, respectively, it is likely that the run exception is not caused by a machine passenger, but may be caused, for example, by a problem with the elevator system 10 itself, or possibly caused by other passengers' call operation. Thus, in step S731, if it is judged as “NO”, it may be generally determined that the run exception may be caused by the elevator system 10 and/or the running state monitoring apparatus 200.

It should be noted that, the running state monitoring method of the fourth embodiment above is mainly to acquire the respective information from one side of the elevator system 10 through the running state monitoring apparatus 200 and analyze and process the information, thereby determining or discovering abnormal running state of the machine passenger 90; in contrast, the running state monitoring method of the first to third embodiments above is mainly to acquire respective feedback information from the machine passenger 90 to determine or discover abnormal running state of the machine passenger 90. It will be understood that the running state monitoring method of the fourth embodiment may be combined with the running state monitoring method of any of the first to third embodiments to further improve the accuracy and comprehensiveness of the running state monitoring.

In the running state monitoring method of the embodiments shown in FIGS. 4-7 above, in the event that the machine passenger 90 is determined to be in an abnormal running state, the running state monitoring apparatus 200 may send at least a first prompt information, e.g. alarm information, representing that the respective machine passenger 90 is in an abnormal running state to the maintenance management system 800; optionally, the first prompt information may also include an identifier of the respective machine passenger, a fault type of the respective machine passenger, the position information of the respective machine passenger relative to the elevator system, etc., which is very helpful for maintenance management personnel to quickly and conveniently locate the fault and timely maintain the machine passenger 90.

It should be noted that, the various running state monitoring methods of the above examples may be implemented primarily in the computer device 200 or the running state monitoring unit 227 of computer device 200.

It should be noted that, the computer device 200 of the above embodiments of the present invention may be implemented by computer program commands, for example, implemented by a dedicated APP, these computer program commands may be provided to a processor of a general purpose computer, a special purpose computer, or other programmable data processing device to constitute the computer device 200 of embodiments of the present invention, also, these commands, which may be executed by a processor of a computer or other programmable data processing device, create units or components for implementing the functions/operations specified in the flowcharts and/or blocks and/or one or more flowchart blocks.

Also, these computer program commands may be stored in a computer-readable memory which may instruct a computer or other programmable processor to implement functions in a specific manner such that the commands stored in the computer-readable memory constitute an article of manufacture that includes the command components implementing the functions/operations specified in one or more blocks of the flowcharts and/or block diagrams.

It should also be noted that, in some alternative implementations, the functions/operations shown in the blocks may occur out of the order shown in the flowcharts. For example, two blocks shown in succession may, in fact, be executed substantially concurrently or the blocks may sometimes be executed in the reverse order, depending upon the functions/operations involved.

It should be noted that, elements disclosed and depicted herein (including flowcharts, block diagrams in the figures) mean logical boundaries between elements. However, according to software or hardware engineering practices, the depicted elements and their functions may be executed on a machine by a computer executable medium having a processor capable of executing program commands stored thereon as a monolithic software structure, as a stand-alone software module, or as a module using external programs, code, services, etc. or any combination thereof, and all such execution schemes may fall within the scope of the present disclosure.

Although the different non-limiting embodiments have specifically illustrated assemblies, implementations of the invention are not limited to these specific combinations. It is possible to use some of the assemblies or features from any of the non-limiting implementations in combination with features or components from any other non-limiting implementations.

Although particular order of steps is shown, disclosed, and claimed, it is to be understood that the steps may be implemented, separated or combined in any order unless otherwise indicated and will still benefit from the present disclosure.

The foregoing description is exemplary and is not defined to be limited thereto. Various non-limiting implementations are disclosed herein, however, one of ordinary skill in the art will recognize that various modifications and alternations will fall within the scope of the appended claims in light of the above teachings. It will, therefore, be understood that within the scope of the appended claims, the disclosure may be practiced other than specific disclosure. For this reason, the appended claims should be studied to determine the true scope and content.

What is claimed is:

1. A method of monitoring a running state of a machine passenger capable of wirelessly interacting with an elevator system, comprising:
judgement step: judging whether a response command for state polling information fed back from the machine passenger is received, and judging whether first state representation information actively sent from the machine passenger for representing that its running state is abnormal is received; and
first state determination step: determining that the respective machine passenger is in an abnormal running state based on a first judgement result of not receiving the response command and a second judgement result of receiving the first state representation information.

2. The method of claim 1, further comprising:
state polling step: wirelessly sending the state polling information to the machine passenger.

3. The method of claim 2, wherein the state polling information is sent to the machine passenger periodically and in case that the machine passenger is in a normal running state, the response command from the machine passenger can be received periodically.

4. The method of claim 1, wherein in the first state determination step, if the first state representation information is received, the respective machine passenger is determined to be in an abnormal running state.

5. The method of claim 1, wherein in the first state determination step, if the response command is not received and the first state representation information is not received, the respective machine passenger is determined to be in a running state of a network connection exception or is in an abnormal running state of a crash.

6. The method of claim 1, wherein if the response command is received but the first state representation information is not received, the respective machine passenger is determined to be in a normal running state.

7. The method of claim 1, wherein the first state representation information further comprises one or more of the following:
an identifier of the respective machine passenger,
a fault type of the respective machine passenger,
position information of the respective machine passenger relative to the elevator system.

8. The method of claim 1, wherein the response command further comprises one or more information of the following:
an identifier of the respective machine passenger,
position information of the respective machine passenger relative to the elevator system.

9. The method of claim 1, further comprising:
prompting step: sending at least first prompt information representing that the respective machine passenger is in an abnormal running state to a maintenance management system.

10. The method of claim 9, wherein the first prompt information further comprises one or more of the following:
an identifier of the respective machine passenger,
a fault type of the respective machine passenger,
position information of the respective machine passenger relative to the elevator system.

11. The method of claim 1, further comprising:
elevator run result acquisition step: acquiring a respective elevator run result corresponding to one or more commands from a certain machine passenger that have been sent to an elevator control device of the elevator system, and judging whether the elevator run result includes a run exception;
association step: if the elevator run result includes a run exception, judging whether the same run exception occurring multiple times is associated with commands sent by the same machine passenger; and
second state determination step: if judged as “YES”, the machine passenger is determined to be in an abnormal running state.

12. The method of claim 11, wherein in the elevator run result acquisition step, if the elevator run result includes the run exception, second prompt information is issued.

13. The interactive security control method of claim 11, wherein the run exception comprises one or more of:
the persistent opening time of a car door/landing door being longer than or equal to a respective predetermined value;
the opening/closing frequency of the car door/landing door being greater than or equal to a respective predetermined value;
the persistent traveling time of the car being shorter than or equal to a respective predetermined value;
the persistent traveling time of the car being longer than or equal to a respective predetermined value;
the elevator control device having a logical error.

14. The method of claim 2, wherein in the state polling step, from a beginning of the call of the machine passenger to an end of an elevator-taking process corresponding to the call, continuously sending the state polling information wirelessly to the machine passenger periodically.

15. The method of claim 1, wherein the judgement step further comprises: judging whether a second state representation information actively sent from the machine passenger for representing that its running state is normal is received;
and, the method further comprises the steps of:
second state determination step: determining that the respective machine passenger is in a normal running state based on a third judgement result of receiving the second state representation information.

16. A computer device comprising a memory, a processor, and a computer program stored on the memory and executable on the processor, wherein the processor, when executing the program, implements the method according to claim 1.

17. A computer readable storage medium having stored thereon a computer program, wherein the program is executable by a processor to implement the method according to claim 1.

18. An elevator system comprising one or more elevator cars, an elevator control device for controlling the traveling of the one or more elevator cars; wherein the system further comprises:
running state monitoring unit configured in the computer device of claim 16;
wherein the elevator control device monitors the running state of a machine passenger capable of wirelessly interacting with the elevator system through the running state monitoring unit.

19. The elevator system of claim 18, wherein the computer device is separately external relative to the elevator control device and is communicatively connected with the elevator control device.
